(19) United States
(12) Patent Application Publication
(10) Pub. No.: US 2026/0243573 A1
(43) Pub. Date: Aug. 20, 2026

(54) METHOD FOR ESTIMATING THE POSITION AND SPEED OF AN AIRCRAFT, AND CORRESPONDING HYBRID NAVIGATION SYSTEM

(71) Applicant: AIRBUS OPERATIONS SAS, Toulouse (FR)

(72) Inventor: Mathieu BRUNOT, Toulouse (FR)

(73) Assignee: AIRBUS OPERATIONS SAS, Toulouse (FR)

(21) Appl. No.: 19/541,183

(22) Filed: Feb. 16, 2026

(30) Foreign Application Priority Data
Feb. 20, 2025 (FR) 2501737

(51) Int. Cl. G01C 21/16

(52) U.S. Cl. CPC G01C 21/183; G01C 21/166

(57) ABSTRACT

A method for estimating the position and speed of an aircraft, by way of a system that includes independent avionic computers receiving inertial measurements supplied by IMUs (IMU1-IMU3) and position measurements supplied by a position sensor. The method includes, for a given independent avionic computer and a current iteration of rank k: upon detection of an IMU fault based on current inertial measurements, transmitting fault information (IP) to a selection sub-module. If a preferred IMU_i is faulty: the selection sub-module (306) selects an IMU_j and transmits, to an estimation sub-module (307), a current inertial measurement nₘ_{ⱼ}(k) of the IMU_j and a previous estimate \hat{b}ⱼ(k−1) of a measurement error model of the IMU_j; the estimation sub-module calculates a current estimate of a state vector based on a previous estimate of the state vector (modified by replacing \hat{b}ᵢ(k−1) with \hat{b}ⱼ(k−1)), nₘ_{ⱼ}(k) and a current position measurement.

### TECHNICAL FIELD

The field of the invention is that of navigation systems for aircraft. These navigation systems are generally included in more global piloting, guidance and navigation (PGN) systems.

More specifically, the present invention relates to a method, implemented by a hybrid navigation system, for estimating the position and speed of an aircraft.

### PRIOR ART

Navigation systems housed on board aircraft comprise estimators the objective of which is to supply a position and speed of aircraft, in three dimensions, either globally (for example with respect to the terrestrial reference frame) or locally (for example with respect to a runway).

The present description focuses on what are known as kinematic estimators, these estimators being said to be kinematic in the sense that they consist in numerically integrating measurements from an inertial measurement unit (IMU) in order to predict position and speed. An IMU corresponds to a sensor of an inertial reference system (IRS). An IMU measures both acceleration and rotational movement.

If the IMU is used without any other sensor, reference is then made to dead reckoning. The IRS gathers data from the IMU and dead reckoning data. On the other hand, the predicted information (concerning position and speed of the aircraft) may be corrected (inertial drift readjustment), periodically or continuously, by one or more position sensors. Without being exhaustive, these position sensors may be a global navigation satellite system (GNSS), an instrument landing system (ILS), a radio altimeter, etc. Reference is then made to a hybrid navigation system or else hybridized navigation system. From an algorithmic point of view, hybridization may be based on various types of estimators: particle filters, an extended Kalman filter (EKF), an unscented Kalman filter (UKF), etc. In order to estimate position and speed accurately and reliably, these estimators must take into account the behaviour of the IMU sensor, by estimating a measurement error model associated with the sensor.

From the point of view of the system architecture, in order to cover the requirements in terms of continuity and availability of the estimate, it is necessary to provide redundancy for the “IMU/estimator/position sensor” chains in order to compensate for a loss.

FIG. 7 schematically illustrates one example of a hybrid navigation system according to the prior art, implementing such redundancy. In this example, the hybrid navigation system comprises three independent avionic computers PGN1′ to PGN3′ each receiving inertial measurements 701 to 703 supplied by three inertial measurement units IMU1 to IMU3 housed on board the aircraft, on the one hand, and position measurements 709 supplied by a position sensor 705 also housed on board the aircraft, on the other hand. Each of the independent avionic computers PGN1′ to PGN3′ comprises a voting sub-module (also called a “voter”) 706, a position estimation sub-module (also called an “estimator”) 707 and a sub-module 708 for detecting and excluding faults with the position sensor 705. The estimator 707 contained in each of the independent avionic computers PGN1′ to PGN3′ supplies a position estimate P1′ to P3′ and a speed estimate (not referenced) for the aircraft. The voter contained in each of the independent avionic computers PGN1′ to PGN3′ receives all three inertial measurements 701 to 703 and, after carrying out a voting process (also called “consolidation” or “selection”), supplies a single measurement 710 to the estimator. The estimator is not informed of the source (IMU) selected by the voter, nor of any change. This strategy works well for some control law strategies, but poses a concern for statistical estimators that model errors of the input datum, and therefore cannot be agnostic of the operation of the voter.

In order for a hybrid navigation system to comply with the integrity requirements, it is necessary to put in place a fault detection strategy. One natural solution is to detect faults downstream of the “IMU/estimator/position sensor” chains, that is to say by comparing the outputs from the independent avionic computers. However, one drawback of such a solution is that it makes it difficult to identify the faulty sensor among the inertial measurement units (IMUs) and the position sensor (used to readjust the inertial drift of the IMUs).

There is therefore a need to provide a solution that makes it possible to further improve fault detection and management in a hybrid navigation system employing redundancy of “IMU/estimator/position sensor” chains.

### SUMMARY OF THE INVENTION

What is proposed is a method for estimating the position and speed of an aircraft, the method being implemented by a hybrid navigation system in the form of electronic circuitry housed on board the aircraft, the hybrid navigation system comprising independent avionic computers each receiving inertial measurements supplied by inertial measurement units, referred to as IMUs, housed on board the aircraft and position measurements supplied by at least one position sensor housed on board the aircraft, each of the independent avionic computers comprising a selection sub-module and an estimation sub-module and being associated with a preferred IMU, denoted IMU_i, from among the IMUs, the method comprising, for a given independent avionic computer and a current iteration of rank k:
detecting a possible fault with one of the IMUs based on current inertial measurements and, if a fault is detected, generating and transmitting, to the selection sub-module, IMU fault information indicating a faulty IMU;
in the selection sub-module:
   if the preferred IMU is not detected as being faulty, transmitting, to the estimation sub-module, a current inertial measurement of a parameter n, denoted nₘ_{ᵢ}(k), supplied by the preferred IMU, the parameter n corresponding to an acceleration or rotational speed;
   if the preferred IMU is detected as being faulty:
      selecting another IMU denoted IMU_j, with i different from j, according to a determined criterion;
      transmitting, to the estimation sub-module, a current inertial measurement of the parameter n, denoted nₘ_{ⱼ}(k), supplied by the other IMU denoted IMU_j; and
      calculating and transmitting, to the estimation sub-module, a previous estimate \hat{b}ⱼ(k−1) of a measurement error model of the other IMU denoted IMU_j;
in the estimation sub-module:
   taking an estimate of a state vector x calculated by the estimation sub-module in a previous iteration of rank k−1 to be a previous estimate \hat{x}(k−1) of said state vector x, said state vector x comprising aircraft position and speed components and an IMU measurement error model;
   if the preferred IMU is not detected as being faulty, calculating a current estimate \hat{x}(k) of the state vector based on the previous estimate \hat{x}(k−1) of the state vector, the current inertial measurement nₘ_{ᵢ}(k) and a current position measurement yₘ(k) supplied by the position sensor;
   if the preferred IMU is detected as being faulty:
      obtaining a modified previous estimate [symbol] (k−1) of the state vector, by replacing an estimate \hat{b}ᵢ(k−1) of the IMU measurement error model contained in the previous estimate \hat{x}(k−1) of the state vector with the previous estimate \hat{b}ⱼ(k−1) of the measurement error model of the other IMU denoted IMU_j, received from the selection sub-module; and
      calculating a current estimate \hat{x}(k) of the state vector based on the modified previous estimate [symbol] (k−1) of the state vector, the current inertial measurement nₘ_{ⱼ}(k) and the current position measurement yₘ(k).

The general principle on which the proposed solution is based is that of decoupling between fault detection within the IMUs and fault detection of the position sensor. The proposed solution also provides a mechanism that makes it possible, when a fault is detected on a preferred IMU (IMU_i) (associated with a given independent avionic computer), to supply the position estimation sub-module (contained in the given independent avionic computer) with an inertial measurement from another IMU (IMU_j) and a previous estimate [symbol] (k−1) of a measurement error model of this other IMU. The position estimation sub-module thereby has the information needed to reconfigure itself and change from using the inertial measurement supplied by the preferred IMU (IMU_i) to using the inertial measurement supplied by the other IMU (IMU_j). The proposed solution thus makes it possible to improve the detection and management of faults in a hybrid navigation system employing redundancy of “IMU/estimator/position sensor” chains.

A measurement error model of an IMU is understood to mean a model comprising one or more components (each corresponding to a distinct type of error) from among: bias, scale factor, alignment, etc.

According to one particular embodiment, the other IMU denoted IMU_j becomes the new preferred IMU for a following iteration of rank k+1 if, in the current iteration of rank k, the selection sub-module selects (606) the other IMU denoted IMU_j because the preferred IMU denoted IMU_i is detected as being faulty.

According to one particular embodiment, if the preferred IMU denoted IMU_i is detected as being faulty, the other IMU denoted IMU_j selected by the selection sub-module is such that: j=i+1 if i<N, and j=1 if i=N, with 1≤i≤N and N being the number of IMUs.

According to one particular embodiment, the detection of a possible fault with one of the IMUs based on current inertial measurements uses a calculation method belonging to the group comprising:
a method using a voting function based on a median value of the inertial measurements supplied by the IMUs; and
a method using a statistical F-test on residuals created by comparing the inertial measurements supplied by the IMUs in pairs.

According to one particular embodiment, the estimation sub-module is a discrete-time linearized or linear Kalman filter, combining:
a prediction, leading to results comprising a prediction of the state vector x(k|k−1) and an associated error covariance P(k|k−1), and a prediction of the position measurement y(k|k−1), based on the modified or unmodified previous estimate \hat{x}(k−1), also denoted x(k−1|k−1), of the state vector and the current inertial measurement, nₘ_{ᵢ}(k) or nₘ_{ⱼ}(k), received from the selection sub-module; and
a correction, leading to the current estimate \hat{x}(k) of the state vector, also denoted x(k|k), and to an associated error covariance P(k|k), based on the results of the prediction and the current position measurement yₘ(k).

According to one particular embodiment, the calculation, by the selection sub-module, of the previous estimate \hat{b}ⱼ(k−1) of the measurement error model of the other IMU denoted IMU_j is based on:
an inertial measurement nₘ_{ⱼ}(k−1) supplied by the other IMU denoted IMU_j in the previous iteration of rank k−1; and
a previous estimate \hat{n}(k−1) of the parameter n calculated by the selection sub-module in the previous iteration of rank k−1.

What is also proposed is a computer program product comprising instructions that cause a processor to carry out the method discussed above according to any one of its embodiments when said instructions are executed by the processor.

What is also proposed is a storage medium storing such instructions that cause the processor to carry out the method discussed above according to any one of its embodiments when said instructions are read from the storage medium and executed by the processor.

What is also proposed is a hybrid navigation system in the form of electronic circuitry housed on board an aircraft, the hybrid navigation system comprising independent avionic computers each receiving inertial measurements supplied by inertial measurement units, referred to as IMUs, housed on board the aircraft and position measurements supplied by at least one position sensor housed on board the aircraft, each of the independent avionic computers comprising a selection sub-module and an estimation sub-module and being associated with a preferred IMU, denoted IMU_i, from among the IMUs, the electronic circuitry of the hybrid navigation system being configured to implement the following, for a given independent avionic computer and a current iteration of rank k:
detecting a possible fault with one of the IMUs based on current inertial measurements and, if a fault is detected, generating IMU fault information indicating a faulty IMU;
in the selection sub-module:
   if the preferred IMU is not detected as being faulty, transmitting, to the estimation sub-module, a current inertial measurement of a parameter n, denoted nₘ_{ᵢ}(k), supplied by the preferred IMU, the parameter n corresponding to an acceleration or rotational speed;
   if the preferred IMU is detected as being faulty:
      selecting another IMU denoted IMU_j, with i different from j, according to a determined criterion;
      transmitting, to the estimation sub-module, a current inertial measurement of the parameter n, denoted nₘ_{ⱼ}(k), supplied by the other IMU denoted IMU_j; and
      calculating and transmitting, to the estimation sub-module, a previous estimate \hat{b}ⱼ(k−1) of a measurement error model of the other IMU denoted IMU_j;
in the estimation sub-module:
   taking an estimate of a state vector x calculated by the estimation sub-module in a previous iteration of rank k−1 to be a previous estimate \hat{x}(k−1) of said state vector x, said state vector x comprising aircraft position and speed components and an IMU measurement error model;
      if the preferred IMU is not detected as being faulty, calculating a current estimate \hat{x}(k) of the state vector based on the previous estimate \hat{x}(k−1) of the state vector, the current inertial measurement nₘ_{ᵢ}(k) and a current position measurement yₘ(k) supplied by the position sensor;
   if the preferred IMU is detected as being faulty:
      obtaining a modified previous estimate [symbol] (k−1) of the state vector, by replacing an estimate \hat{b}ᵢ(k−1) of the IMU measurement error model contained in the previous estimate \hat{x}(k−1) of the state vector with the previous estimate (k−1) of the measurement error model of the other IMU denoted IMU_j, received from the selection sub-module; and
      calculating a current estimate \hat{x}(k) of the state vector based on the modified previous estimate [symbol] (k−1) of the state vector, the current inertial measurement nₘ_{ⱼ}(k) and the current position measurement yₘ(k).

What is also proposed is an aircraft comprising a hybrid navigation system as mentioned above.

### BRIEF DESCRIPTION OF THE DRAWINGS

The abovementioned features of the invention, as well as others, will become more clearly apparent on reading the following description of at least one exemplary embodiment, said description being given with reference to the appended drawings, in which:

FIG. 1 schematically illustrates a side view of an aircraft equipped with a hybrid navigation system;

FIG. 2 schematically illustrates one example of a hardware architecture of the hybrid navigation system of FIG. 1;

FIG. 3 schematically illustrates one example of a software architecture of the hybrid navigation system of FIG. 1;

FIG. 4 schematically illustrates one embodiment of the IMU fault detection and identification module, appearing in FIG. 3;

FIG. 5 schematically illustrates one embodiment of the three sub-modules contained in each of the independent avionic computers, and appearing in FIG. 3;

FIG. 6 schematically illustrates one example of an aircraft position and speed estimation algorithm executed by the hybrid navigation system; and

FIG. 7 schematically illustrates one example of a hybrid navigation system according to the prior art.

### DETAILED DESCRIPTION OF EMBODIMENTS

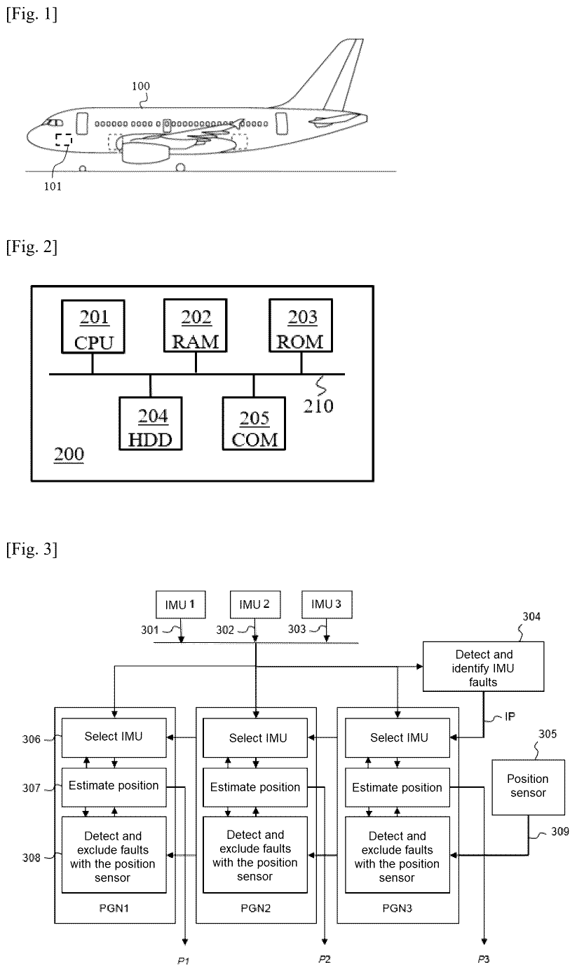

FIG. 1 schematically illustrates a side view of an aircraft 100 equipped with a hybrid navigation system 101. The hybrid navigation system 101 is an item of on-board electronic equipment. For example, it forms part of electronic circuitry of the avionics of the aircraft 100. As described in detail below, it comprises a plurality of independent avionic computers.

In one embodiment, these independent avionic computers (computers of the aircraft 100) are flight control computers (FCCs) intended to implement aircraft navigation and guidance functions. For certification reasons, these flight control computers must satisfy reliability and temporal determinism criteria that limit the use of recent computers/processors. This means having to use computers/processors that are sufficiently tried and tested. As a result, the flight control computers have limited computing capabilities and resources.

FIG. 2 schematically illustrates one example of a hardware architecture of each of the independent avionic computers (referenced 200) of the hybrid navigation system 101, which then comprises the following, connected by a communication bus 210: a processor or central processing unit (CPU) 201; a random access memory RAM 202; a read-only memory ROM 203, for example a flash memory; a data storage device, such as a hard disk drive (HDD), or a storage medium reader, such as a secure digital (SD) card reader 204; at least one communication interface 205 allowing the independent avionic computer 200 (contained in the hybrid navigation system 101) to interact with the avionics of the aircraft 100.

The processor 201 is capable of executing instructions forming a computer program and loaded into the RAM 202 from the ROM 203, from an external memory (not shown), from a storage medium, such as an SD card, or from a communication network (not shown). When the independent avionic computer 200 (contained in the hybrid navigation system 101) is powered up, the processor 201 is capable of reading the abovementioned instructions from the RAM 202 and of executing them. When they are read (from the RAM 202 or a storage medium) and executed by the processor 201, these instructions (which form a computer program) cause the processor 201 to execute the behaviours, steps and algorithm described here.

All or some of the behaviours, steps and algorithm described here may thus be implemented in software form by executing a set of instructions using a programmable machine, such as a digital signal processor (DSP) or a microcontroller, or be implemented in hardware form by a machine or a dedicated component (“chip”) or a dedicated set of components (“chipset”), such as a field-programmable gate array (FPGA) or an application-specific integrated circuit (ASIC). Generally speaking, the hybrid navigation system 101 comprises electronic circuitry arranged and configured to implement the behaviours, steps and algorithms described here.

FIG. 3 schematically illustrates one example of a software architecture of the hybrid navigation system 101 of FIG. 1, which, as already mentioned above, is implemented in the form of electronic circuitry housed on board the aircraft.

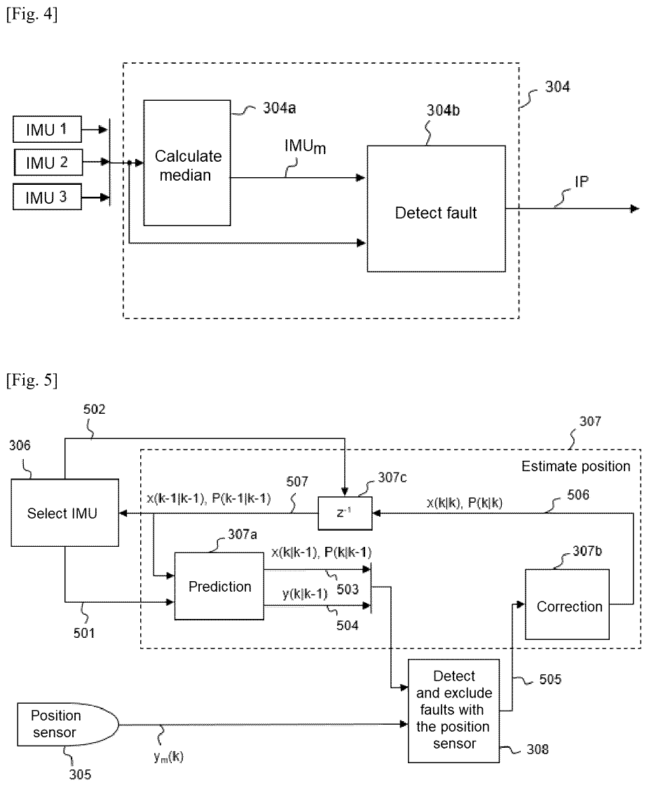

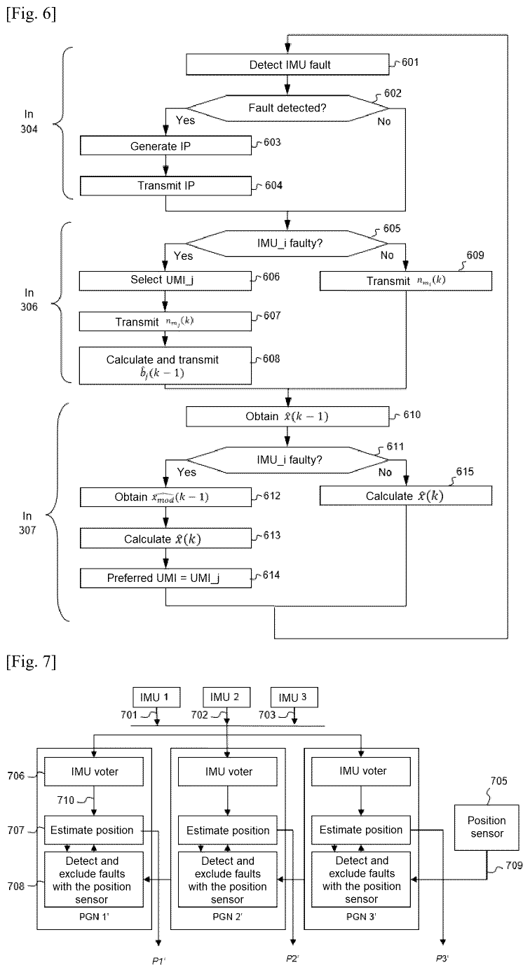

In this example, the hybrid navigation system comprises a UMI fault detection and identification module 304, which receives inertial measurements 301 to 303 supplied by a plurality of IMUs (three in this example, referenced IMU1, IMU2 and IMU3) housed on board the aircraft, and which (as described below with reference to FIGS. 4 and 6) generates IMU fault information (referenced IP).

The hybrid navigation system furthermore comprises a plurality of independent avionic computers (three in this example, referenced PGN1, PGN2 and PGN3), each receiving:
inertial measurements 301 to 303 supplied by a plurality of IMUs (three in this example, referenced IMU1, IMU2 and IMU3), housed on board the aircraft;
position measurements 309 supplied by at least one position sensor 305 housed on board the aircraft; and the IMU fault information (IP) generated by the IMU fault detection and identification module 304.

Each of the independent avionic computers PGN1 to PGN3 comprises three sub-modules: a selection sub-module 306, an estimation sub-module 307 and a sub-module 308 for detecting and excluding faults with the position sensor. The selection sub-module 306 receives the inertial measurements 301 to 303 supplied by the plurality of IMUs (IMU1 to IMU3) and the IMU fault information (IP), and exchanges information with the estimation sub-module 307. The estimation sub-module 307 exchanges information with the estimation sub-module 307 and with the sub-module 308 for detecting and excluding faults with the position sensor, and provides a position estimate (P1 to P3) and a speed estimate (not referenced) for the aircraft.

The overall operation of the hybrid navigation system will now be summarized. In a first stage, the inertial measurements 301 to 303 of the three IMUs are sent to the module 304, which detects and identifies the possible fault from among the three IMUs (in the event of a detected fault, supplying the IMU fault information). Next, the three inertial measurements 301 to 303, along with the result of the detection and identification (that is to say the IMU fault information), are transmitted to the three independent avionic computers PGN1 to PGN3. In each independent avionic computer, the selection sub-module 306 selects the IMU able to be used by the estimation sub-module 307, taking into account the IMU fault information. The estimation sub-module 307 then calculates a position based on the data from the position sensor and the selected IMU, along with an estimate of the measurement error of the selected IMU. This estimated error is then retransmitted to the selection sub-module 306, in order to prepare for a potential change of source (that is to say of IMU) if an IMU fault is identified. In parallel, the sub-module 308 (for detecting and excluding faults with the position sensor) monitors the position sensor (for example GNSS integrity monitoring, fault detection, warning thresholds, event detection, etc.).

More detailed operation, in one particular embodiment, is described below with reference to FIGS. 5 and 6.

With regard to the detection and identification of faults with the IMU, FIG. 3 illustrates one embodiment in which the hybrid navigation system comprises a single IMU fault detection and identification module 304 that serves the three independent avionic computers PGN1-PGN3. In another embodiment, each independent avionic computer PGN1-PGN3 has its own IMU fault detection and identification module, coupled with its selection sub-module 306.

In the embodiment illustrated in FIG. 4, the IMU fault detection and identification module 304 comprises a median calculation sub-module 304a and a fault detection sub-module 304b.

The median calculation sub-module 304a receives the inertial measurements 301 to 303 (supplied by the plurality of IMUs, IMU1 to IMU3) and calculates the median thereof (referenced IMUₘ). The fault detection sub-module 304b compares each of the inertial measurements 301 to 303 with the median value IMUₘ over a sliding time window (with or without overlap). If the deviation between one of the inertial measurements 301 to 303 and the median value IMUₘ is greater than a predetermined threshold, the IMU that supplied this inertial measurement is detected (that is to say considered) as being faulty. In this case, the fault detection sub-module 304b generates the IMU fault information (IP) that indicates the IMU that has been detected as being faulty.

In another embodiment, the IMU fault detection and identification module 304 carries out detection with an F-test (statistical test) on the residuals created by comparing the inputs in pairs. The analysis of the results of the three tests then gives the identification of the fault.

FIG. 5 schematically illustrates one embodiment of the three sub-modules (306, 307 and 308) contained in each of the independent avionic computers PGN1 to PGN3.

Each of the independent avionic computers PGN1 to PGN3 is associated with a preferred IMU, denoted IMU_i with i∈{1,2,3}, from among the IMUs (IMU1 to IMU3).

Consideration will now be given to:
a given independent avionic computer PGN_i, with i∈{1, 2, 3}, the associated preferred IMU of which is IMU_i by default;
an iteration of rank k, corresponding to a time k (as detailed below with reference to FIG. 6, the method carried out by the hybrid navigation system 101 is an iterative method); and
a parameter n, measured by the IMUs and corresponding to an acceleration (or speed increment) or rotational speed (or rotation increment), regardless of the axis.

At the time k (iteration of rank k), for the parameter n, the following applies:

$${n}_{{m}_{i}} ( k ) = n ( k ) + {b}_{i} ( k ) + {v}_{i} ( k ) \qquad ( 1 )$$

where:
nₘ_{ᵢ}(k) is the measurement of the parameter n supplied by IMU_i;
n(k) is the true value of the parameter n;
bᵢ(k) is a measurement error model of IMU_j. In one particular embodiment, on which the remainder of the description is based, the measurement error model of IMU_j is, for technical simplification, assimilated to the measurement bias of IMU_j. In other words, consideration will be given, in the remainder of the description, to an embodiment in which the measurement error model of an IMU is, for technical simplification, limited to the bias of this IMU. Other embodiments are possible, in which the measurement error model of an IMU comprises one or more components (each corresponding to a distinct type of error) from among: bias, scale factor, alignment, etc.; and
vᵢ(k) is the measurement noise of IMU_i.

Ignoring the measurement noise vᵢ(k), the parameter n may be estimated as follows:

$$\hat{n} ( k ) = {n}_{{m}_{i}} ( k ) - {\hat{b}}_{i} ( k ) \qquad ( 2 )$$

The estimate \hat{n} is bias-free if and only if the estimate \hat{b}ᵢ is bias-free and if measurement noise is zero on average. In practice, assuming the slowly variable bias, that is to say assuming \hat{b}ᵢ(k)=\hat{b}ᵢ(k−1), the following applies:

$$\hat{n} ( k ) = {n}_{{m}_{i}} ( k ) - {\hat{b}}_{i} ( k - 1 ) \qquad ( 3 )$$

As detailed below, the estimation sub-module 307 supplies the selection sub-module 306 with a previous estimate \hat{b}ᵢ(k−1) of the measurement bias of IMU_i. More specifically, \hat{b}ᵢ(k−1) is contained in \hat{x}(k−1), which is transmitted by the estimation sub-module 307 to the selection sub-module 306, and which is a previous estimate of a state vector x (this state vector comprises aircraft position and speed components, along with the measurement bias bᵢ).

Therefore, if, in the iteration of rank k, IMU_i is not detected as being faulty by the IMU fault detection and identification module 304, the selection sub-module 306 may calculate \hat{n} (k) according to equation (3) and transmit the measurement nₘ_{ᵢ}(k) to the estimation sub-module 307.

On the other hand, if, in the iteration of rank k, IMU_i is detected as being faulty by the IMU fault detection and identification module 304, the selection sub-module 306 must allow the estimation sub-module 307 to use another measurement. To this end, the selection sub-module 306 selects another IMU, denoted IMU_j, with i different from j, according to a determined criterion. For example: j=i+1 if i<N, and j=1 if i=N, with 1≤i≤N and N being the number of IMUs. In the particular case presented above where N=3, the following applies:

$$j = \{ \begin{matrix}i + 1 & if i < 3 \\ 1 & else\end{matrix} \qquad ( 4 )$$

In addition, the selection sub-module 306:
calculates a previous estimate \hat{b}ⱼ(k−1) of the measurement bias of IMU_j; and
transmits, to the estimation sub-module 307, this estimate \hat{b}ⱼ(k−1), on the one hand, and nₘ_{ⱼ}(k) the measurement of the parameter n supplied by IMU_j, on the other hand.

The selection sub-module 306 calculates \hat{b}ⱼ(k−1) as follows:

$${\hat{b}}_{j} ( k - 1 ) = {n}_{{m}_{j}} ( k - 1 ) - \hat{n} ( k - 1 ) \qquad ( 5 )$$

where \hat{n}(k−1) was calculated, according to equation (3), in the previous iteration of rank k−1 and then stored.

In addition, with a view to possible use in a following iteration of rank k+1, the selection sub-module 306 calculates \hat{n}(k) according to the following equation, and then stores \hat{n}(k):

$$\hat{n} ( k ) = {n}_{{m}_{j}} ( k ) - {\hat{b}}_{j} ( k - 1 ) \qquad ( 3 )$$

Finally, if, in the iteration of rank k, IMU_i (preferred IMU in this iteration of rank k) is detected as being faulty (leading to the selection of IMU_j by the selection sub-module 306), then, for the following iteration of rank k+1, IMU_j becomes the new preferred IMU.

In summary, and by way of example:
case A: if, in the iteration of rank k, IMU1 (preferred IMU in this iteration of rank k) is not detected as being faulty, the selection sub-module 306:
   calculates \hat{n}(k) with equation (3); and
   transmits nₘ_{₁}(k) to the estimation sub-module 307;
case B: if, in the iteration of rank k, IMU1 (preferred IMU in this iteration of rank k) is detected as being faulty, the selection sub-module 306:
   selects IMU2;
   calculates \hat{b}₂(k−1) with equation (5);
   transmits \hat{b}₂(k−1) and nₘ_{₂}(k) to the estimation sub-module 307; and
   calculates \hat{n}(k) with equation (3′);
if, following case B, in the iteration of rank k+1, IMU2 (preferred IMU in this iteration of rank k+1) is not detected as being faulty, the selection sub-module 306:
   calculates \hat{n}(k) with equation (3); and
   transmits nₘ_{₂}(k) to the estimation sub-module 307;
if, following case B, in the iteration of rank k+1, IMU2 (preferred IMU in this iteration of rank k+1) is detected as being faulty, the selection sub-module 306:
   selects IMU3;
   calculates \hat{b}₃(k−1) with equation (5);
   transmits b₃(k−1) and nₘ_{₂}(k) to the estimation sub-module 307; and
   calculates \hat{n}(k) with equation (3′).

In one variant embodiment, in order to take into account measurement noise, it is possible, instead of the estimate of the parameter \hat{n}(k) defined by equation (3′), to use a stochastic estimator such as the recursive least squares algorithm, with or without a forgetting factor. More simplistically, it is possible to use a low-pass filter, but this then requires a sparse configuration in order not to introduce latency that degrades the performance of the estimator. Regardless of the solution chosen, the objective is to have an estimated bias, \hat{b}ⱼ, reliable enough to reset the corresponding state vector of the estimator (referred to above as the selection sub-module 306).

The operation of the estimation sub-module 307 will now be described in detail. At the time k (iteration of rank k), the operation may be decomposed into two distinct functions: a prediction function (block referenced 307a) and a correction function (block referenced 307b).

The prediction function 307a numerically integrates the measurements (reference 501) of the IMU selected by the selection sub-module 306 (measurement nₘ_{ᵢ}(k) if the preferred IMU_i is not detected as being faulty and measurement nₘ_{ⱼ}(k) if the preferred IMU_i is detected as being faulty). The prediction function 307a also receives the state vector predicted in the previous iteration of rank k−1, x(k−1|k−1), and the associated error covariance P(k−1|k−1) (reference 507). These two elements 507 are obtained using a function 307c that applies a delay of a period to the result 506 of the correction function 307b. Based on the inputs 501 and 507, the prediction function 307a generates a predicted state vector x(k|k−1) and the associated error covariance P(k|k−1) (reference 503) (see equation (7) described below). Reference is made to kinematic prediction, since the model is based on the kinematics of the rigid solid.

The prediction function also predicts the position measurement y(k|k−1) (reference 504) using the model of the corresponding position sensor 305.

Moreover, the prediction function 307a transmits, to the selection sub-module 306, the state vector predicted in the previous iteration of rank k−1, x(k−1|k−1), and the associated error covariance P(k−1|k−1) (reference 507). As mentioned above, a previous estimate \hat{b}₁(k−1) of the measurement bias of IMU_i is contained in the state vector predicted in the previous iteration of rank k−1.

The correction function 307b takes into account the position measurement yₘ(k) in order to obtain the estimated state vector x(k|k) and its error covariance P(k|k) (reference 506) (see equation (6) described below), based on the result 505 from the module 308 for detecting and excluding faults with the position sensor.

The state vector to be estimated, x, comprises the (three-dimensional) components of position and speed, along with the orientation angles, the IMU biases and any biases for the position sensor in question.

As mentioned above, if the preferred IMU_i is detected as being faulty, the selection sub-module 306 selects IMU_j, calculates a previous estimate \hat{b}ⱼ(k−1) of the measurement bias of IMU_j and transmits this previous estimate \hat{b}ⱼ(k−1) to the estimation sub-module 307. This transmission is shown in FIG. 5 by the arrow referenced 502. Upon receipt of \hat{b}ⱼ(k−1), the function 307c updates (modifies) the predicted state vector x(k−1|k−1) by replacing, within it, the previous estimate \hat{b}ᵢ(k−1) of the measurement bias of IMU_i with the previous estimate \hat{b}ⱼ(k−1) of the measurement bias of IMU_j.

In one embodiment, the estimation sub-module 307 is a discrete-time linearized or linear Kalman filter. The correction function 307b is defined by the following equations:

$$K ( k ) = P ( k \vert k - 1 ) {C}^{T} ( k ) {S}^{- 1} ( k ) \qquad ( 6 )$$

$$x ( k \vert k ) = x ( k \vert k - 1 ) + K ( k ) ε ( k )$$

$$P ( k \vert k ) = {( I - K ( k ) C ( k ) )}^{T} P ( k \vert k - 1 ) ( I - K ( k ) C ( k ) + K ( k ) R K ( k ) )$$

where C (k) is the matrix of the observation model such that y(k|k−1)=C (k) x(k|k−1), S is the innovation covariance matrix (cf. Equation 8), K is the Kalman gain and R is the measurement noise matrix.

In this same embodiment, the prediction function 307a calculates the prediction of the state, x, and the associated error covariance, P, according to the following equations:

$$x ( k \vert k - 1 ) = A ( k ) x ( k - 1 \vert k - 1 ) \qquad ( 7 )$$

$$P ( k \vert k - 1 ) = A ( k ) P ( k - 1 \vert k - 1 ) {A}^{T} ( k ) + Q$$

where A is the state prediction model and Q is the covariance matrix of the process noise associated with this prediction.

In one embodiment, the sub-module 308 for detecting and excluding faults with the position sensor corresponds to a chi-2 innovation test, ε, defined, in an Euclidean space, by:

$$ε ( k ) = {y}_{m} ( k ) - y ( k \vert k - 1 ) \qquad ( 8 )$$

and having the matrix covariance S(k). This innovation ε is therefore the difference between the measurement vector, yₘ, coming from the position sensor, and the predicted position

$$y ( k \vert k - 1 ) .$$

In another embodiment, the sub-module 308 for detecting and excluding faults with the position sensor comprises a bank of estimators each integrating a different fault hypothesis.

FIG. 6 schematically illustrates one example of an aircraft position and speed estimation algorithm executed by the hybrid navigation system 101. More specifically, in this example, consideration is given to a given independent avionic computer (from among PGN1 to PGN3) and a current iteration of rank k. Steps 601 to 604 are executed by the IMU fault detection and identification module 304 (the case of FIG. 3 is adopted, in which the module 304 serves the three independent avionic computers PGN1-PGN3). Steps 605 to 609 are executed by the selection sub-module 306 (contained in the given independent avionic computer). Steps 610 to 617 are executed by the estimation sub-module 307 (contained in the given independent avionic computer).

In step 601, the IMU fault detection and identification module 304 detects a possible fault with one of the IMUs based on current inertial measurements. If no IMU fault is detected (negative response to the test in step 602), step 605 is performed directly. If an IMU fault is detected (affirmative response to the test in step 602), the module 304 generates (step 603) and transmits (step 604), to the selection sub-module 306, the IMU fault information (IP) indicating which IMU is faulty (for example in the form of an IMU index). Then, step 605 is performed.

In step 605, the selection sub-module 306 checks, based on the IMU fault information (IP), whether the preferred IMU (associated with the given independent avionic computer) is detected as being faulty.

If the preferred IMU is detected as being faulty (positive response to the test in step 605), the selection sub-module 306 executes:
step 606, in which it selects the other IMU denoted IMU_j, with i different from j, according to a determined criterion (see discussion of FIG. 5);
step 607, in which it transmits, to the estimation sub-module 307, the current inertial measurement of the parameter n, denoted nₘ_{ⱼ}(k), supplied by the other IMU denoted IMU_j; and
step 608, in which it calculates and transmits, to the estimation sub-module 307, the previous estimate \hat{b}ⱼ(k−1) of the measurement bias of the other IMU denoted IMU_j.

If the preferred IMU is not detected as being faulty (negative response to the test in step 605), the selection sub-module 306 executes step 609, in which it transmits, to the estimation sub-module 307, the current inertial measurement of the parameter n, denoted nₘ_{ᵢ}(k), supplied by the preferred IMU. As explained above, the parameter n corresponds to an acceleration (or speed increment) or rotational speed (or rotation increment).

After step 608 or step 609 (depending on the result of the test step 605), the estimation sub-module 307 executes step 610, in which it takes an estimate of the state vector calculated by the estimation sub-module in a previous iteration of rank k−1 to be a previous estimate \hat{x}(k−1) of the state vector x (as described above, this comprises aircraft position and speed components and an IMU measurement bias).

Next, in step 611, the estimation sub-module 307 checks, based on the IMU fault information (IP), whether the preferred IMU (associated with the given independent avionic computer) is detected as being faulty.

If the preferred IMU is detected as being faulty (positive response to the test in step 611), the estimation sub-module 307 executes:
step 612, in which it obtains the modified previous estimate [symbol] (k−1) of the state vector, by replacing the estimate \hat{b}ᵢ(k−1) of the IMU measurement bias contained in the previous estimate \hat{x}(k−1) of the state vector with the previous estimate \hat{b}ⱼ(k−1) of the measurement bias of the other IMU denoted IMU_j, received from the selection sub-module;
step 613, in which it calculates the current estimate \hat{x}(k) of the state vector based on the modified previous estimate [symbol] (k−1) of the state vector, the current inertial measurement nₘ_{ⱼ}(k) and the current position measurement yₘ(k); and
step 614, in which IMU_j becomes the new preferred IMU for the following iteration of rank k+1 (that is to say before the return to step 601 for a new iteration).

If the preferred IMU is not detected as being faulty (negative response to the test in step 611), the estimation sub-module 307 executes step 615, in which it calculates the current estimate \hat{x}(k) of the state vector based on the previous estimate x(k−1) of the state vector, the current inertial measurement nₘ_{ᵢ}(k) and the current position measurement yₘ(k) supplied by the position sensor. The method then returns to step 601 for a new iteration. In other words, IMU_i remains the preferred IMU for the following iteration of rank k+1.

1. A method for estimating the position and speed of an aircraft, the method being implemented by a hybrid navigation system in the form of electronic circuitry housed on board the aircraft, the hybrid navigation system comprising independent avionic computers each receiving inertial measurements supplied by inertial measurement units (IMUs) housed on board the aircraft and position measurements supplied by at least one position sensor housed on board the aircraft, each of the independent avionic computers comprising a selection sub-module and an estimation sub-module and being associated with a preferred IMU, denoted IMU_i, from among the IMUs, the method comprising, for a given independent avionic computer and a current iteration of rank k:
detecting a possible fault with one of the IMUs based on current inertial measurements and, if a fault is detected, generating and transmitting, to the selection sub-module, IMU fault information (IP) indicating a faulty IMU;
in the selection sub-module:
if the preferred IMU is not detected as being faulty, transmitting, to the estimation sub-module, a current inertial measurement of a parameter n, denoted nₘ_{ᵢ} (k), supplied by the preferred IMU, the parameter n corresponding to an acceleration or speed increment or rotational speed or rotation increment;
if the preferred IMU is detected as being faulty:
selecting another IMU denoted IMU_j, with i different from j, according to a determined criterion;
transmitting, to the estimation sub-module, a current inertial measurement of the parameter n, denoted nₘ_{ⱼ}(k), supplied by the other IMU denoted IMU_j; and
calculating and transmitting, to the estimation sub-module, a previous estimate \hat{b}ⱼ(k−1) of a measurement error model of the other IMU denoted IMU_j;
in the estimation sub-module:
taking an estimate of a state vector x calculated by the estimation sub-module in a previous iteration of rank k−1 to be a previous estimate \hat{x}(k−1) of said state vector x, said state vector x comprising aircraft position and speed components and an IMU measurement error model;
if the preferred IMU is not detected as being faulty, calculating a current estimate \hat{x}(k) of the state vector based on the previous estimate \hat{x}(k−1) of the state vector, the current inertial measurement nₘ_{ᵢ}(k) and a current position measurement yₘ(k) supplied by the position sensor;
if the preferred IMU is detected as being faulty:
obtaining a modified previous estimate [symbol] (k−1) of the state vector, by replacing an estimate \hat{b}ᵢ(k−1) of the IMU measurement error model contained in the previous estimate \hat{x}(k−1) of the state vector with the previous estimate \hat{b}ⱼ(k−1) of the measurement error model of the other IMU denoted IMU_j, received from the selection sub-module; and
calculating a current estimate \hat{x}(k) of the state vector based on the modified previous estimate [symbol] (k−1) of the state vector, the current inertial measurement nₘ_{ⱼ}(k) and the current position measurement yₘ(k).

2. The method according to claim 1, wherein the other IMU denoted IMU_j becomes the new preferred IMU for a following iteration of rank k+1 if, in the current iteration of rank k, the selection sub-module selects the other IMU denoted IMU_j because the preferred IMU denoted IMU_i is detected as being faulty.

3. The method according to claim 1, wherein, if the preferred IMU denoted IMU_i is detected as being faulty, the other IMU denoted IMU_j selected by the selection sub-module is such that: j=i+1 if i<N, and j=1 if i=N, with 1≤i≤N and N being the number of IMUs.

4. The method according to claim 1, wherein the detection of a possible fault with one of the IMUs based on current inertial measurements uses a calculation method belonging to the group comprising:
a method using a voting function based on a median value of the inertial measurements supplied by the IMUs; and
a method using a statistical F-test on residuals created by comparing the inertial measurements supplied by the IMUs in pairs.

5. The method according to claim 1, wherein the estimation sub-module is a discrete-time linearized or linear Kalman filter, combining:
a prediction, leading to results comprising a prediction of the state vector x(k|k−1) and an associated error covariance P(k|k−1), and a prediction of the position measurement y(k|k−1), based on the modified or unmodified previous estimate x(k−1), also denoted x(k−1|k−1), of the state vector and the current inertial measurement, nₘ_{ᵢ}(k) or nₘ_{ⱼ}(k), received from the selection sub-module; and
a correction, leading to the current estimate \hat{x}(k) of the state vector, also denoted x (k|k), and to an associated error covariance P(k|k), based on the results of the prediction and the current position measurement yₘ(k).

6. The method according to claim 1, wherein the calculation, by the selection sub-module, of the previous estimate \hat{b}ⱼ(k−1) of the measurement error model of the other IMU denoted IMU_j is based on:
an inertial measurement nₘ_{ⱼ}(k−1) supplied by the other IMU denoted IMU_j in the previous iteration of rank k−1; and
a previous estimate \hat{n}(k−1) of the parameter n calculated by the selection sub-module in the previous iteration of rank k−1.

7. (canceled)

8. A non-transitory storage medium storing a computer program comprising instructions that cause a processor to carry out the method according to claim 1 when said instructions are read and executed by the processor.

9. A hybrid navigation system in the form of electronic circuitry housed on board an aircraft, the hybrid navigation system comprising:
independent avionic computers each receiving inertial measurements supplied by inertial measurement units (IMUs) housed on board the aircraft and position measurements supplied by at least one position sensor housed on board the aircraft, each of the independent avionic computers comprising a selection sub-module and an estimation sub-module and being associated with a preferred IMU, denoted IMU_i, from among the IMUs, the electronic circuitry of the hybrid navigation system being configured to implement the following, for a given independent avionic computer and a current iteration of rank k:
detecting a possible fault with one of the IMUs based on current inertial measurements and, if a fault is detected, generating IMU fault information indicating a faulty IMU;
in the selection sub-module:
if the preferred IMU is not detected as being faulty, transmitting, to the estimation sub-module, a current inertial measurement of a parameter n, denoted nₘ_{ᵢ}(k), supplied by the preferred IMU, the parameter n corresponding to an acceleration or rotational speed;
if the preferred IMU is detected as being faulty:
selecting another IMU denoted IMU_j, with i different from j, according to a determined criterion;
transmitting, to the estimation sub-module, a current inertial measurement of the parameter n, denoted nₘ_{ⱼ}(k), supplied by the other IMU denoted IMU_j; and
calculating and transmitting, to the estimation sub-module, a previous estimate \hat{b}ⱼ(k−1) of a measurement error model of the other IMU denoted IMU_j;
in the estimation sub-module:
taking an estimate of a state vector x calculated by the estimation sub-module in a previous iteration of rank k−1 to be a previous estimate \hat{x}(k−1) of said state vector x, said state vector x comprising aircraft position and speed components and an IMU measurement error model;
if the preferred IMU is not detected as being faulty, calculating a current estimate \hat{x}(k) of the state vector based on the previous estimate \hat{x}(k−1) of the state vector, the current inertial measurement nₘ_{ᵢ}(k) and a current position measurement yₘ (k) supplied by the position sensor;
if the preferred IMU is detected as being faulty:
obtaining a modified previous estimate [symbol] (k−1) of the state vector, by replacing an estimate \hat{b}ᵢ(k−1) of the IMU measurement error model contained in the previous estimate \hat{x}(k−1) of the state vector with the previous estimate \hat{b}ⱼ(k−1) of the measurement error model of the other IMU denoted IMU_j, received from the selection sub-module; and
calculating a current estimate \hat{x}(k) of the state vector based on the modified previous estimate [symbol] (k−1) of the state vector, the current inertial measurement nₘ_{ⱼ}(k) and the current position measurement yₘ(k).

10. The aircraft comprising a hybrid navigation system according to claim 9.
